(19) United States
(12) Patent Application Publication
(10) Pub. No.: US 2020/0346338 A1
(43) Pub. Date: Nov. 5, 2020

(54) Vent Cleaner

(71) Applicants: Michael Apolaya, Indianapolis, IN (US); Timothy Blackburn, Indianapolis, IN (US); Ryan Amonette, Indianapolis, IN (US); Stanley McCabe DeLuna-Dabrowski, Indianapolis, IN (US); Elizabeth Butterfield, Fishers, IN (US)

(72) Inventors: Michael Apolaya, Indianapolis, IN (US); Timothy Blackburn, Indianapolis, IN (US); Ryan Amonette, Indianapolis, IN (US); Stanley McCabe DeLuna-Dabrowski, Indianapolis, IN (US); Elizabeth Butterfield, Fishers, IN (US)

(21) Appl. No.: 16/398,688

(22) Filed: Apr. 30, 2019

(51) Int. Cl. B25G 1/04; A47L 9/24

(52) U.S. Cl. CPC B25G 1/04; F24F 2221/22; A47L 9/248

(57) ABSTRACT

A vent cleaner that is easily adjustable with a simple squeezing action. The trigger on the handle of the vent cleaner, is squeezed to extend it to the desired height required. The general purpose of the invention is to provide a tool for a user at ground level to conveniently clean a vent that is at an elevated position relative to the user. The vent cleaner can accommodate a plurality of attachments via the C-joint end.

### TECHNICAL FIELD

The present disclosure of this invention relates to a vent cleaner; more specifically, related to an adjustable vent cleaner that is operated manually by a user.

### BACKGROUND

This section introduces aspects that may help facilitate a better understanding of the disclosure. Accordingly, these statements are to be read in this light and are not to be understood as admissions about what is or is not prior art.

Frequently referred to as vents, registers, grilles and returns are frequently found at or near ceilings in homes. These fixtures are meant to facilitate the movement of air throughout a building. With the advent of HVAC systems, vents also for the distribution of hot or cold air from a heating and cooling system to provide thermal comfort and good air quality. However, over time, these air ducts can become obstructed with dirt and dust, which lowers efficiency of the ventilation system and may lead to wear and tear on the HVAC unit. As hot air rises, vents in modern buildings are often located near ceilings, making methods for reaching and cleaning them valuable.

Throughout the existence of ceiling vents, several methods of cleaning them have been invented, one of the most popular features being telescoping handles. Operation of these devices typically involved mounting a cleaning pad or element to a plurality of telescoping shafts or sections that may be adjusted between a compressed and fully extended position to reach the vent while standing on the floor. The operator could extend the telescoping shafts or sections via depression of a mechanism at the base of the handle. Typically, these cleaning devices can only be adjusted for operation in two positions. There have been no products developed that offer the flexibility of allowing for a multitude of positions.

Therefore, there is an unmet need for a novel approach to clean vents without the aforementioned limitations of the prior art.

### SUMMARY

An extendable tool for vent cleaning is disclosed. The tool includes a handle housing adapted to be moved from a i) rest position; to ii) a deployed position, the handle housing is biased to the rest position by a biasing member, a linkage mechanism coupled to the handle housing and configured to be placed into i) an extended position when the handle housing is in the deployed position, and ii) a retracted position when the handle housing is in the rest position, the linkage mechanism having a selective plurality of linkages configured to add lengths to the link mechanism for a predetermined length of the vent, and an attachment member coupled to the linkage mechanism, the attachment member adapted to be coupled to a cleaning apparatus selected from the group consisting of a brush, a vacuum hose, a vacuum brush, and a vacuum nozzle.

A method of cleaning vents is also disclosed. The method includes coupling a cleaning tool to an extendable tool for vent cleaning. The extended tool for vent cleaning includes a handle housing adapted to be moved from a i) rest position; to ii) a deployed position, the handle housing is biased to the rest position by a biasing member, a linkage mechanism terminating with an activation handle coupled to the handle housing and configured to be placed into i) an extended position when the handle housing is in the deployed position, and ii) a retracted position when the handle housing is in the rest position, the linkage mechanism having a selective plurality of linkages configured to add lengths to the link mechanism for a predetermined length of the vent, and an attachment member coupled to the linkage mechanism, the attachment member adapted to be coupled to a cleaning apparatus selected from the group consisting of a brush, a vacuum hose, a vacuum brush, and a vacuum nozzle. The method also includes placing the cleaning tool within the vent, and squeezing the activation handle against the handle housing to thereby articulate the plurality of linkages to thereby extend the cleaning tool to the extended position within the vent.

### BRIEF DESCRIPTION OF DRAWINGS

FIG. 1 is a perspective cutaway view of a vent cleaner, according to the present disclosure.

FIG. 2 is a perspective view of the vent cleaner, according to the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 10%, within 5%, or within 1% of a stated value or of a stated limit of a range.

In the present disclosure, the term “substantially” can allow for a degree of variability in a value or range, for example, within 90%, within 95%, or within 99% of a stated value or of a stated limit of a range.

One or more specific embodiments of the present disclosure will be described below. In an effort to provide a concise description of these embodiments, all features of an actual implementation may not be described in the specification. For example, this specification will only reference the needed properties of “pin joints” and not a specific joint assembly to use only the type and nature of the degree of freedom allowed and that one skilled in the arts would know how to satisfy in each specific case. As with all engineering designs some slight modifications may need to be made for the actual implementation of this design. Furthermore, specifics on a method of fabrication and manufacture shall also be left to one of ordinary skill in the arts with the benefit of this disclosure.

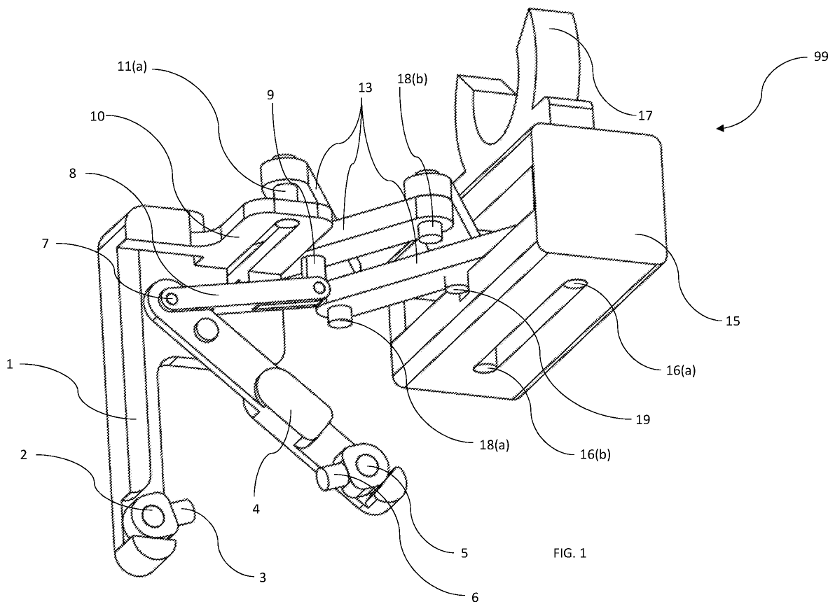

In this disclosure the term “rest position” shall refer to the current status of the design as shown in FIG. 1.

In this disclosure the term “translation” denotes linear movement not involving rotation and when combined with “outward” or “inward” means that 90% of the motion will be in the same direction but in some cases can also have slight upward or downward motion.

A novel highly adjustable system to extend the reach of various cleaning apparatuses that overcomes the aforementioned limitations of the prior art is provided in this disclosure.

FIG. 1 gives an underside right-hand cross-sectional view of the apparatus including a handle housing 1, connected at its base within the housing to bias member receptacle 3, activation handle 4 connected within handle housing 1 near the fillet on handle housing 1 directly above the base of handle housing 1, activation linkage 8 connected within the upper section of handle housing 1; slot plate 10 is connected to the top external part of the handle housing 1 and is connected to a plurality of linkages 13 which is in turn connected to Adaptable housing 15.

Furthermore, bias member receptacle 3 is connected to handle housing 1 using bias member pin 2, such that bias member receptacle 3 shall remain fixed in its position relative to the housing. Bias member receptacle 3 is contained within the handle housing 1.

Additionally, activation handle 4 is connected to handle housing 1 using activation handle pin 7. The joint created at this connection shall have one rotational degree of freedom allowed while restricting all translational degrees of freedom. The allowed rotational degree of freedom shall be in the same parallel plane through the center of the housing. Activation handle 4 is also connected near its base to bias member receptacle 6 by bias member pin 5. Activation link pin 12 also restrains the far end of activation handle 4 within handle housing 1 and connects it to activation link 8 such that upon a force being applied to the activation handle 4 activation link 8 shall be allowed to slide within handle housing 1.

Furthermore, Biasing member 14 shall be restrained between bias member receptacle 3 and bias member receptacle 6 wherein during compression of the biasing member due to force being applied on activation handle 4 energy shall be stored such that its release in the event of the force applied to activation handle 4 being removed causes the activation handle 4 and thus the activation link 8 connected to return to rest position.

Similarly, for FIG. 1 activation linkage 12 is connected at its outward end to the connecting points at the base of master pin 9, a pin that is cylindrical with a T-shaped connector extrusions at its base allowing firm connection to activation linkage 12. As described above as activation link 8 translates through the handle housing 1 outwardly, a force being exerted upon master pin 9 causing translational movement in the same direction. A removal of the force on the activation handle 4 then causing translation in the opposite direction when returning to rest.

Additionally, slot plate 10 as it is connected to the top of handle housing 1 as stated above, allowing handle slot pin 11 (a) to move within the slot of slot plate 10 such that the entire plurality of X linkages 13 are allowed to move from the rest X position and retracted to the extended X position.

Furthermore, as the above mentioned master pin 9 translates toward the outward position a plurality of X linkages 13 are forced to constrict, extending the reach of the device from the lower range to the upper range. A plurality of X linkages 13 uses a plurality of pin joints 18 connected at each terminal end and then a center plurality of pin joints 19 to allow the plurality of X linkages to rotate around and extend each X linkage from the rest X position to the extended X position.

Similarly for FIG. 1 adaptable housing 15 contains a slot identical in size to the slot in the above mentioned slot plate 10 that allow terminal slot pin 16 (a) and 16 (b) to translate freely allowing the plurality of X linkages 13 to reach the extended X position as well as restraining the plurality of X linkages 13 to the rest X position.

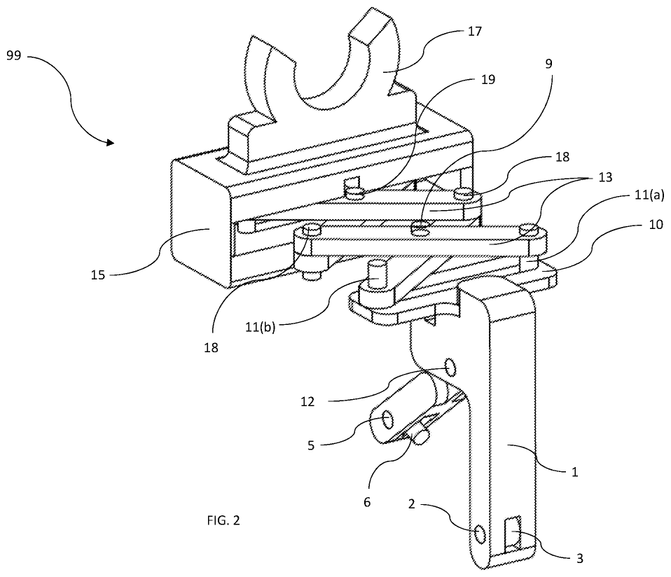

FIG. 2 displays a posterior upper view of the apparatus allowing handle slot pin 11(b) and its corresponding handle slot pin 11(a) described above in FIG. 1 and acts in a similar way as the terminal slot pin 16(a) and 16(b) operate on the terminal end of the apparatus as shown above in FIG. 1.

Those having ordinary skill in the art will recognize that numerous modifications can be made to the specific implementations described above. The implementations should not be limited to the particular limitations described. Other implementations may be possible.

What is claimed is:

1. An extendable tool for vent cleaning comprising:
a handle housing adapted to be moved from a i) rest position; to ii) a deployed position, the handle housing is biased to the rest position by a biasing member;
a linkage mechanism coupled to the handle housing and configured to be placed into i) an extended position when the handle housing is in the deployed position, and ii) a retracted position when the handle housing is in the rest position, the linkage mechanism having a selective plurality of linkages configured to add lengths to the link mechanism for a predetermined length of the vent; and
an attachment member coupled to the linkage mechanism, the attachment member adapted to be coupled to a cleaning apparatus selected from the group consisting of a brush, a vacuum hose, a vacuum brush, and a vacuum nozzle.

2. The extendable tool of claim 1, wherein the handle housing is cylindrical in shape.

3. The extendable tool of claim 1, wherein the selective plurality of linkages form a plurality of pairs of linkages wherein each member of a pair of the plurality is centrally linked to a counter-member of the pair and both members are linked at distal ends to i) distal ends of members of another pair of the plurality, or ii) distal ends of a terminating member disposed at ends of the linkage mechanism.

4. The extendable tool of claim 3, wherein one of the pairs of linkages is coupled to an activation linkage at a corresponding central location of the pair, the activation linkage is coupled to the handle housing and configured to move corresponding to the movement of the handle housing, the handle housing and the activation linkage are configured to be operated by a user's hand.

5. The extendable tool of claim 4, wherein the one of the pairs is the pair closest to the handle housing.

6. A method of cleaning vents, comprising:
coupling a cleaning tool to an extendable tool for vent cleaning, the extended tool for vent cleaning comprising:
a handle housing adapted to be moved from a i) rest position; to ii) a deployed position, the handle housing is biased to the rest position by a biasing member,
a linkage mechanism terminating with an activation handle coupled to the handle housing and configured to be placed into i) an extended position when the handle housing is in the deployed position, and ii) a retracted position when the handle housing is in the rest position, the linkage mechanism having a selective plurality of linkages configured to add lengths to the link mechanism for a predetermined length of the vent, and
an attachment member coupled to the linkage mechanism, the attachment member adapted to be coupled to a cleaning apparatus selected from the group consisting of a brush, a vacuum hose, a vacuum brush, and a vacuum nozzle;
placing the cleaning tool within the vent; and
squeezing the activation handle against the handle housing to thereby articulate the plurality of linkages to thereby extend the cleaning tool to the extended position within the vent.

7. The method of claim 6, wherein the handle housing is cylindrical in shape.

8. The method of claim 6, wherein the selective plurality of linkages form a plurality of pairs of linkages wherein each member of a pair of the plurality is centrally linked to a counter-member of the pair and both members are linked at distal ends to i) distal ends of members of another pair of the plurality, or ii) distal ends of a terminating member disposed at ends of the linkage mechanism.
